(19) United States
(12) Patent Application Publication
(10) Pub. No.: US 2014/0113218 A1
(43) Pub. Date: Apr. 24, 2014

(54) Encapsulated Nanoporous Metal Nanoparticle Catalysts

(71) Applicant: THE JOHNS HOPKINS UNIVERSITY, Baltimore, MD (US)

(72) Inventors: Jonah Daedalus Erlebacher, Chevy Chase, MD (US); Joshua D. Snyder, Baltimore, MD (US)

(73) Assignee: THE JOHNS HOPKINS UNIVERSITY, Baltimore, MD (US)

(21) Appl. No.: 13/658,085

(22) Filed: Oct. 23, 2012

(51) Int. Cl. B01J 31/02; B01J 23/42; B01J 23/89; B01J 35/02; B01J 25/00; H01M 4/86; H01M 4/98; H01M 4/92; B01J 35/12; B01J 21/18

(52) U.S. Cl. CPC B01J 31/0292; B01J 35/12; B01J 23/42; B01J 23/892; B01J 21/18; B01J 25/00; H01M 4/8605; H01M 4/98; H01M 4/8652; H01M 4/921; B01J 35/026; Y10S 977/773; Y10S 977/81; Y10S 977/899; Y10S 977/948; B82Y 40/00
USPC 429/524; 502/300; 502/167; 502/339; 502/326; 502/182; 502/1; 429/532; 429/527; 429/525; 429/526; 977/773; 977/810; 977/899; 977/948

(57) ABSTRACT

Catalysts comprising porous metal nanoparticles, which are individually encapsulated with a reaction-enhancing material, and their use in fuel cell catalysis are provided.

### FEDERALLY SPONSORED RESEARCH OR DEVELOPMENT

This invention was made in part with United States Government support under DE-SC0008686 awarded by the U.S. Department of Energy (DOE). The U.S. Government has certain rights in the invention.

### BACKGROUND

Of the challenges associated with making proton exchange membrane fuel cells (PEMFCs) (M. Debe, Nature 486, 43 (2012)), perhaps the greatest challenge is the fuel cell cathode, which is responsible for the majority of efficiency losses due to the sluggish kinetics of the oxygen reduction reaction (ORR) (H. Gasteiger, S. Kocha, B. Sompalli, F. Wagner, Appl. Catal. B 56, 9 (2005)). Current state-of-the art catalysts for this reaction utilize a sophisticated hierarchical catalyst architecture in which 5-nm-scale platinum-based alloy nanoparticles are supported on larger carbon particles, wherein the carbon particles themselves are bound into a conducting ink by a proton-conducting polymer that is porous at a larger, 100-nm scale, allowing flow of reactants (oxygen, protons, electrons) and product (water) into and out of the catalyst layer. Such flow is not optimized, however—under conditions of low current (overpotential) oxygen reduction has slow reaction rates, and at high current (overpotential), product water tends to accumulate on the catalyst surface, slowing mass transport of O₂ and limiting power.

Historically, many significant improvements in the power density generated by PEMFCs have been the result of advances in the engineering of the overall architecture of the catalyst layer. For instance, replacement of unsupported Pt black catalysts with Pt nanoparticles having diameters in the range of about 1 nm to about 5 nm, supported on high surface area (about 800 m²g⁻¹ to about 1000 m²g⁻¹), conductive carbon supports resulted in the first major increase in electrochemically active surface area (ECSA) (M. Wilson, S. Gottesfeld, J. Applied Electrochem. 22, 1 (1992)). While the total Pt metals content was indeed significantly reduced, the catalyst inks in the membrane electrode assemblies (MEAs) of this period used a polytetrafluoroethylene (PTFE) binder, which allowed only very limited proton transport from the PEM to the Pt nanoparticle surfaces, as well as physically blocking many active sites on the catalyst surface. Development of a solubilized proton exchange polymer, Nafion®, and its integration into the catalyst layer as a binder and proton conductor, led to further order-of-magnitude increases in activity within the PEMFC cathode. The presence of Nafion® creates a “triple-phase-boundary” within the catalyst layer, significantly improving the interaction between the reactant gas, electrocatalytic surface, and proton conducting medium, and leads to higher catalyst utilization; its use further decreased the required amounts of precious metal in cathode catalysts (S. Lee, S. Mukerjee, J. McBreen, Y. Rho, Y. Kho, T. Lee, Electrochim. Acta 43, 3693 (1998)).

More recent innovations in cathode catalysis have focused on improvement in the ORR by alloying Pt with transition metals (V. Stamenkovic, B. Fowler, B. Mun, G. Wang, P. Ross, C. Lucas, N. Markovic, Science 315, 493 (2007); J. Kim, S. Lee, C. Carlton, Y. Shao-Horn, Electrochem. Solid-State Lett. 14, B110 (2011); J. Wu, J. Zhang, Z. Peng, S. Yang, F. Wagner, H. Yang, J. Am. Chem. Soc. 132, 4984 (2010)) or forming Pt-skinned or core-shell nanostructures (J. Wang, H. Inada, L. Wu, Y. Zhu, Y. Choi, P. Liu, W. Zhou, R. Adzic, J. Am. Chem. Soc. 131, 17298 (2009); V. Stamenkovic, B. Mun, K. Mayrhofer, P. Ross, N. Markovic, J. Am. Chem. Soc. 128, 8813 (2006); J. Zhang, Y. Mo, M. Vukmirovic, R. Klie, K. Saski, R. Adzic, J. Phys. Chem. B 108, 10955 (2004)). Such multicomponent alloy catalysts improve cathode performance by adjusting ORR kinetics via optimization of the interaction between the catalyst surface and reactant O₂. The presence of sub-surface transition metals creates a shift in the electronic (d-band center) and geometric structure of Pt surface atoms, limiting the surface coverage of ORR intermediate species and increasing the number of available active sites (J. Greely, I. Stephens, A. Bondarenko, T. Johansson, H. Hansen, T. Jaramillo, J. Rossmeisl, I. Chorkendorff, J. Norskov, Nature Chem. 1, 552 (2009)). The integration of alloy or nanostructured catalysts into functioning PEMFCs has been challenging, however, as the synthesis methods are difficult and small alloy nanoparticle catalysts are subject to a number of degradation mechanisms, such as agglomeration and/or dissolution of the less noble component (dealloying).

The ORR is well-known to be first-order in O₂ partial pressure. As a consequence of the presence of a thin product water layer on the catalyst surface (fuel cells are highly humidified and water also is produced as a product of the cathodic ORR), the concentration of O₂ at the catalyst surface is, at most, equal to the solubility of O₂ in this water layer.

### SUMMARY

In some aspects, the presently disclosed subject matter provides a catalyst for chemical reactions, comprising: a porous metal nanoparticle capable of catalyzing a plurality of reactants to provide a reaction product, wherein the porous metal nanoparticle is encapsulated by a reaction-enhancing material; wherein the reaction-enhancing material enhances attraction of at least one reactant of the plurality of reactants into one or more pores defined by the porous metal catalyst; and wherein the reaction-enhancing material enhances expulsion of the reaction product from the one or more pores defined by the porous metal catalyst.

In other aspects, the presently disclosed subject matter provides a fuel cell, comprising: a first electrode; a second electrode spaced apart from the first electrode; and an electrolyte arranged between the first and the second electrodes, wherein at least one of the first and second electrodes is coated with a porous metal nanoparticle capable of catalyzing a plurality of reactants to provide a reaction product; wherein the porous metal nanoparticle is encapsulated by a reaction-enhancing material; wherein the reaction-enhancing material enhances attraction of at least one reactant of the plurality of reactants into one or more pores defined by the porous metal catalyst; and wherein the reaction-enhancing material enhances expulsion of the reaction product from the one or more pores defined by the porous metal catalyst.

In yet other aspects, the presently disclosed subject matter provides a method for preparing an encapsulated porous metal nanoparticle catalyst, the method comprising: providing a metal alloy nanoparticle; supporting the metal alloy nanoparticle on a conductive support, such as carbon black; electrochemically de-alloying the metal alloy to provide a porous metal catalyst that catalyzes a plurality of reactants to provide a reaction product; and encapsulating the porous metal nanoparticles with a reaction-enhancing material such that the reaction-enhancing material encapsulates partially or entirely the porous metal nanoparticle catalyst, wherein the reaction-enhancing material enhances attraction of at least one reactant of the plurality of reactants into the pores defined by the porous metal catalyst, and wherein the reaction-enhancing material enhances expulsion of the reaction product from the pores defined by the porous metal catalyst.

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### BRIEF DESCRIPTION OF THE FIGURES

Having thus described the presently disclosed subject matter in general terms, reference will now be made to the accompanying Figures, which are not necessarily drawn to scale, and wherein:

FIG. 1 is a schematic illustrating the representative components of the presently disclosed encapsulated nanoporous nanoparticle catalysts. The nucleus of the catalyst is a high surface area nanoporous nanoparticle, which allows the particle to be encapsulated by an ionic liquid (IL) whose purpose is to mediate transport of reactants and products to and from the catalyst surface. For electrocatalysis, the encapsulated nanoporous nanoparticle catalyst is attached to a conductive substrate;

FIG. 2 shows high resolution transmission electron micrographs (HRTEM) of nanoporous nickel-platinum (np-NiPt) nanoparticles encapsulated with the IL [MTBD][beti], supported on carbon. This protic, hydrophobic IL increases the residence time of oxygen near the catalyst surface, thereby increasing activity. Product water is expelled from this catalyst, easing water management in operating fuel cells and facilitating high current densities;

FIG. 3 is a TEM of an unencapsulated np-NiPt particle on a carbon support. The lack of an organic “halo” around this particle in comparison to those shown in FIG. 2 is evidence that what is seen surrounding the particles in FIG. 2 is in fact IL and not organic impurities from processing or sample preparation techniques;

FIG. 4 shows representative cyclic voltammograms (CVs) of 20 wt. % Pt/C (Johnson Matthey), np-NiPt/C and np-NiPt/C+[MTBD][beti] recorded in deaerated 0.1 M HClO₄ at room temperature with a sweep rate of 50 mV s⁻¹. The arrow indicates the significant increase in the onset potential for platinum oxidation due to catalyst encapsulation;

FIG. 5 is a cyclic voltammogram of np-NiPt/C impregnated with dry [MTBD][beti] IL and np-NiPt/C impregnated with water/acid equilibrated [MTBD][beti] IL. CVs recorded at 50 mV s⁻¹ in argon purged 0.1 M HClO₄ at 25° C.;

FIG. 6 shows results of oxygen reduction reaction (ORR) measurements for 20 wt. % Pt/C, np-NiPt/C and np-NiPt/C+[MTBD][beti] recorded in oxygen saturated 0.1 M HClO₄ at 60° C., with a sweep rate of 20 mV s⁻¹ and a rotation rate of 1600 rpm. Loading on the GC disk in all cases was 12 μg_{Pt} cm⁻². Currents were corrected for ohmic iR drops, and are reported as current density per geometric area of disk. Encapsulation led to an approximately 60 mV reduction in the overpotential for oxygen reduction (i.e., from the standard reaction potential of 1.2 V), due to encapsulation, leading to a shift in the half-wave potential to 0.96 V vs. RHE;

FIG. 7 demonstrates characteristics of hydrogen/oxygen PEM fuel cells employing cathodes made with the presently disclosed encapsulated nanoporous nanoparticle catalysts: (top) raw data polarization curves for 20 wt. % Pt/C, np-NiPt/C, np-NiPt/C with [MTBD][beti] IL added to the catalyst layer in a volume equal to the pore volume of the nanoporous nanoparticles in the catalyst layer and np-NiPt/C with [MTBD][beti] IL added to the catalyst layer in a volume 2.5 times the pore volume of the nanoporous nanoparticles in the catalyst layer. In the mass transport-limited region (above approximately 1000 mA cm⁻²), a small amount of IL helps repel water (1×IL), leading to larger currents, but too much IL stymies mass transport to the catalyst surface (2.5×IL) in this regime; and

FIG. 8 shows ORR curves for 20 wt. % Pt/C and Pt/C 20 wt. % Pt/C impregnated with [MTBD][beti] IL. ORR curves recorded in O₂ saturated 0.1 M HClO₄ at 60° C. with a rotation rate of 1600 rpm. Potentials were corrected for iR loss within the electrolyte. The observed shift in half-wave potential is approximately 15 mV, which is less than one-quarter the shift observed for the presently disclosed encapsulated nanoporous nanoparticles.

### DETAILED DESCRIPTION

The presently disclosed subject matter now will be described more fully hereinafter with reference to the accompanying Figures, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

### I. Encapsulated Nanoporous Metal Nanoparticle Catalysts

The presently disclosed subject matter provides a technologically viable and sustainable path to the development of high-efficiency, high power proton exchange membrane fuel cells (PEMFCs) employing a minimal amount of precious metal catalyst. By encapsulating high surface area nanoporous nanoparticles with a hydrophobic, protic ionic liquid possessing high oxygen solubility, new functionality is introduced into the oxygen reduction cathode catalyst architecture that helps to confine oxygen near the catalyst surface and shuttle product water away.

As disclosed hereinabove, the ORR is first-order in O₂ partial pressure and, as a consequence of the presence of a thin product water layer on the catalyst surface, the concentration of O₂ at the catalyst surface is, at most, equal to the solubility of O₂ in this water layer. The presently disclosed subject matter provides nanoporous nanoparticles that are encapsulated by a reaction-enhancing material whose role is to (a) keep water away from the catalyst surface while (b) maintaining a higher O₂ partial pressure at the catalyst surface (equivalently, O₂ residence time) without substantially affecting mass transport.

Such encapsulation of the nanoporous nanoparticle catalysts can lead to the following beneficial properties. At low overpotential, i.e., relatively high voltages where the ORR is not mass transported-limited by O₂, the activity will be multiplied by a factor equal to the ratio of solubilities between this second phase and water. Thermodynamically, the encapsulation medium changes the chemical potential gradient toward the catalyst surface (not the total driving force, which is determined by the electrochemical potential), biasing O₂ to remain near the catalyst surface. At high overpotential and high current densities, flooding due to too-fast production of water would be ameliorated by physical repulsion of condensed water from the catalyst volume. Note, however, that traditional non-porous nanoparticle catalysts are not suitable for encapsulation, because any coating might simply wash away during operation. For encapsulation to be possible, the nanoparticles must be rendered porous on a scale smaller than the diameter of the particle, for example, by creating through-channels that hold the encapsulating material in place.

In particular embodiments, the presently disclosed subject matter provides a nanostructured catalyst architecture employing high surface area, nanoporous Pt/Ni alloy nanoparticles encapsulated with a hydrophobic, protic IL. The properties of the IL, primarily high O₂ solubility, modify the chemical environment around the particles to improve ORR kinetics, and in fuel cells, secondary advantages of the IL-encapsulated catalysts include better water management near the catalyst surface. The expansive library and potential variety of organic chemical species available for use as both cations and anions of protic ILs opens the door for further improvements in activity with the presently disclosed encapsulated catalyst architecture where IL properties, such as protonic conductivity, hydrophobicity, equilibrium water content and O₂ solubility and diffusivity, may be synthetically tuned for optimal performance.

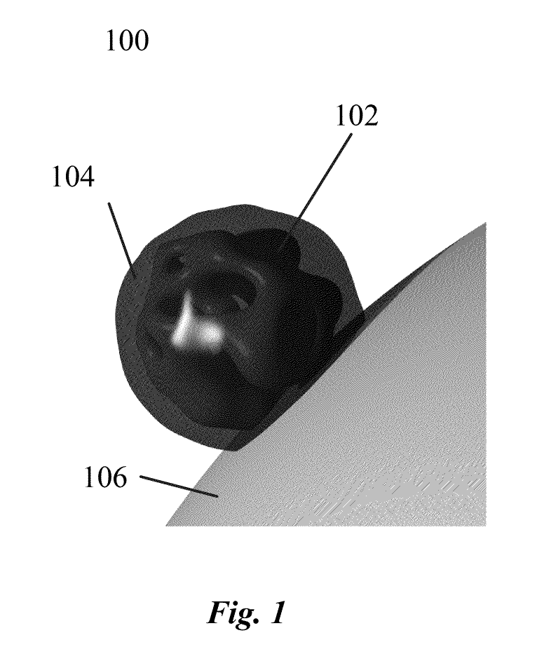

Referring now to FIG. 1, a schematic illustration of an embodiment of encapsulated nanoporous metal nanoparticle catalyst 100 is provided. Catalyst 100 includes nanoporous metal catalytic nanoparticle 102 and reaction-enhancing material 104 disposed within the pores and encapsulating the porous metal nanoparticle catalyst. Porous metal catalyst 102 catalyzes a plurality of reactants to provide a reaction product. In certain embodiments, two, three or more reactants can comprise reaction-enhancing material 104, depending on the particular application of the presently disclosed subject matter. In addition, in some embodiments, there could be more than one reaction product. Reaction-enhancing material 104 enhances attraction of at least one reactant of the plurality of reactants into the pores defined by porous metal catalyst 102. Reaction-enhancing material 104 thus helps to keep the reactants trapped in the pores of the porous metal catalyst until the reaction occurs. In one particular embodiment, reaction-enhancing material 104 is an ionic liquid. Reaction-enhancing material 104 also enhances expulsion of the reaction product from the pores defined by the porous metal catalyst. In some embodiments, carbon support 106 provides electrical conduction to the encapsulated porous metal nanoparticle so that electrochemical reactions can be catalyzed.

As further disclosed herein below in the Examples, half-cell measurements show particular embodiments of the presently disclosed encapsulated catalyst. In some embodiments, the np-NiPt/C+[MTBD][beti] encapsulated catalyst is nearly an order of magnitude more active than commercial Pt/C, a result that can be directly translated into operational PEMFCs. One characteristic of the presently disclosed encapsulated nanoporous nanoparticle catalysts is that the activity of the catalyst trends with properties of the ionic liquid. This characteristic indicates that further significant improvements in fuel cell catalysis can be realized through utilizing ionic liquids having optimized protonic conductivity, thermal and electrochemical stability, hydrophobicity and O₂ solubility, and diffusivity.

Accordingly, the presently disclosed subject matter provides a catalyst and catalyst architecture including a nanoporous nanoparticle encapsulated by a reaction-enhancing material. In some embodiments, the presently disclosed subject matter includes: (1) a process to produce nanoporous nanoparticles; (2) a process to support the nanoporous nanoparticles on carbon; and (3) a process to encapsulate the nanoporous nanoparticles with an ionic liquid. By making an catalyst comprising nanoporous metal nanoparticles, wherein each nanoparticle is encapsulated by an oxophilic, hydrophobic and protic ionic liquid (IL), structure and functionality can be introduced at an intermediate scale such that the ORR activity can be, in practice, magnified by nearly an order of magnitude in practice.

A. Encapsulated Porous Metal Nanoparticle Catalyst

In some embodiments, the presently disclosed subject matter provides a catalyst for chemical reactions, comprising: a porous metal nanoparticle capable of catalyzing a plurality of reactants to provide a reaction product, wherein the porous metal nanoparticle is encapsulated by a reaction-enhancing material; wherein the reaction-enhancing material enhances attraction of at least one reactant of the plurality of reactants into one or more pores defined by the porous metal catalyst; and wherein the reaction-enhancing material enhances expulsion of the reaction product from the one or more pores defined by the porous metal catalyst.

In particular embodiments, the reaction-enhancing material comprises a liquid in which at least one reactant is more soluble than a local environment that exposes the encapsulated porous metal nanoparticle to at least one reactant. In more particular embodiments, the reaction-enhancing material comprises a liquid in which the reaction product is less soluble than a local environment that receives the reaction product. In some embodiments, the porous metal nanoparticle catalyzes an oxygen reduction reaction to provide H₂O as a reaction product, wherein O₂ of the oxygen reduction reaction is more soluble in the reaction-enhancing material than the H₂O reaction product, and the reaction-enhancing material is hydrophobic. In certain embodiments, the reaction-enhancing material comprises an ionic liquid. In more certain embodiments, the ionic liquid is at least one of MTBD-beti or MBTB-Tf₂N. One of ordinary skill in the art would recognize upon review of the presently disclosed subject matter that other ionic liquids could be suitable for use with the presently disclosed subject matter.

In some embodiments, the porous metal nanoparticle has a specific surface area that is greater than about 5 m²/g and less than about 100 m²/g. In particular embodiments, the porous metal nanoparticle has a specific surface area that is greater than 40 m²/g and less than 50 m²/g. In more particular embodiments, the porous metal nanoparticle has a specific surface area of about 41 m²/g.

In some embodiments, the porous metal nanoparticle comprises platinum (Pt). In particular embodiments, the porous metal nanoparticle comprises an alloy. In more particular embodiments, the porous metal nanoparticle comprises nickel (Ni). In even more particular embodiments, the porous metal nanoparticle comprises an alloy comprising platinum (Pt) and nickel (Ni). In certain embodiments, the porous metal nanoparticle comprises an alloy of the following formula: PtₓNi₁₋ₓ, wherein x has a numerical range from about at least 0.6 to about 1. In more certain embodiments, x is 0.67. In some embodiments, the porous metal nanoparticle comprises a metal selected from the group consisting of titanium, iron, cobalt, nickel, copper, iridium, rhenium, aluminum, manganese, palladium, osmium, rhodium, vanadium, chromium, and combinations thereof.

In some embodiments, the porous metal nanoparticle has a diameter ranging from about 10 nm to about 100 nm. In particular embodiments, the porous metal nanoparticle has a diameter ranging from about 12 nm to about 15 nm.

In certain embodiments, the porous metal nanoparticle is supported on carbon.

In some embodiments, the porous metal nanoparticle has an ensemble average pore diameter and an ensemble average ligament diameter that are each less than a diameter of the porous metal nanoparticle itself. In particular embodiments, the porous metal nanoparticle has an ensemble average pore diameter ranging from about 2 nm to about 10 nm and an ensemble average ligament diameter ranging from about 2 nm and about 10 nm.

B. Fuel Cells Comprising the Presently Disclosed Encapsulated Porous Metal Nanoparticle Catalysts

In some embodiments, the presently disclosed subject matter provides a fuel cell, comprising: a first electrode; a second electrode spaced apart from the first electrode; and an electrolyte arranged between the first and the second electrodes, wherein at least one of the first and second electrodes is coated with a porous metal nanoparticle capable of catalyzing a plurality of reactants to provide a reaction product; wherein the porous metal nanoparticle is encapsulated by a reaction-enhancing material; wherein the reaction-enhancing material enhances attraction of at least one reactant of the plurality of reactants into one or more pores defined by the porous metal catalyst; and wherein the reaction-enhancing material enhances expulsion of the reaction product from the one or more pores defined by the porous metal catalyst. More particularly, the encapsulated porous metal nanoparticle catalyst comprising the fuel cell is as disclosed immediately hereinabove.

C. Method for Preparing an Encapsulated Porous Metal Nanoparticle Catalyst

In some embodiments, the presently disclosed subject matter provides a method for preparing an encapsulated porous metal nanoparticle catalyst, the method comprising: providing a metal alloy nanoparticle; supporting the metal alloy nanoparticle on a conductive carbon support; electrochemically de-alloying the metal alloy to provide a porous metal catalyst that catalyzes a plurality of reactants to provide a reaction product; and encapsulating the porous metal nanoparticles with a reaction-enhancing material such that the reaction-enhancing material encapsulates partially or entirely the porous metal nanoparticle catalyst, wherein the reaction-enhancing material enhances attraction of at least one reactant of the plurality of reactants into the pores defined by the porous metal catalyst, and wherein the reaction-enhancing material enhances expulsion of the reaction product from the pores defined by the porous metal catalyst.

In some embodiments, the adding the reaction-enhancing material adds a liquid reaction-enhancing material that is drawn into and held within one or more pores defined by the porous metal nanoparticle catalyst by capillary forces. In some embodiments, the reaction-enhancing medium is mixed with a solvent and porous metal nanoparticles and then the solvent is evaporated away. In particular embodiments, the solvent comprises ethanol.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The synthetic descriptions and specific examples that follow are only intended for the purposes of illustration, and are not to be construed as limiting in any manner to make compounds of the disclosure by other methods.

### Example 1

### Synthesis and Properties of Carbon-Supported Nanoporous Metal Nanoparticles

In one embodiment, encapsulated nanoporous nanoparticles catalysts were made by first synthesizing Ni-rich Pt/Ni nanoparticles to create nanoporous nanoparticles, followed by supporting the nanoporous nanoparticles on carbon, and then encapsulating these nanoparticles with an IL to a shell thickness on the order of about 1 nm.

Ni-rich Pt/Ni nanoparticles were synthesized as follows: In a glove box (Labconco), 0.73 mmol Ni(II) acetylacetonate (Ni(acac)₂) (Sigma Aldrich, 97%), 3 mmol 1-adamantanecarboxylic acid (ACA) (Sigma Aldrich, 99%), 0.15 mmol 1,2-tetradecandiol (TDD) (Sigma Aldrich, 90%), 0.10 mmol borane-tert-butylamine (BtB) (Sigma Aldrich, 97%), 4 mL oleylamine (Sigma Aldrich, 70%), and 10 mL diphenyl ether (DPE) (Sigma Aldrich, ReagentPlus, 99%) were loaded into a four-neck flask and stirred at 500 rpm under flowing argon (Roberts Oxygen, Zero grade). The solution was stirred and heated to 225° C., and then 0.27 mmol Pt(II) acetylacetonate (Pt(acac)₂) (Sigma Aldrich, 97%) dissolved in 3 mL dichlorobenzene (DCB) (Sigma Aldrich, 99%) was quickly injected into the solution. The solution was held at 225° C. for 60 min. and then allowed to cool to room temperature while still under an argon atmosphere. The cooled solution was then dispersed in ethanol (Pharmco-Aaper, 200 proof) and centrifuged (Thermo Scientific, CL2) to separate out the particles. Cleaned particles were loaded onto a carbon support (XC-72R, Cabot) via a colloidal deposition process to make the NiPt/C precursor material. Organic surface contaminants were removed by heating the supported catalysts at 185° C. in a tube furnace (Lindberg) under flowing O₂/Ar 10%/90% for 1 hour, followed by a homogenization anneal under H₂/Ar 5%/95% (Roberts Oxygen, Zero grade) at 400° C. for 1 hour.

In this embodiment, the synthesis method was used to make homogeneous alloy nanoparticles with approximately a 15-nm diameter. Variation of this procedure can be used to synthesize particles having a diameter ranging from about 5 nm to about 50 nm. Different alloy constituents other than Pt or Ni can be made by using different precursor salts. For instance, in place of Ni, cobalt, iron, copper, or other elements could be used; in place of Pt, ruthenium, gold, silver, or other elements could be used.

The presently disclosed synthesis method also leads to particles with homogeneous composition, which has been recognized as a critically important factor in whether a particle can be dealloyed to form a porous particle (J. Snyder, I. McCue, K. Livi, J. Erlebacher, J. Am. Chem. Soc. 134, 8633 (2012)). Current methods to produce alloy nanoparticles, such as so-called salt impregnation, do not result either in homogenous particles or a nearly monodisperse size distribution (A. Marcu, G. Toth, R. Srivastava, P. Strasser, J. Power Sources, 208, 288 (2012)).

The nanoporous nanoparticles used in this embodiment are approximately 15 nm in diameter, with a variation in diameter less than about 5 nm (“monodisperse”). This diameter was chosen as it is above a diameter threshold such that electrochemical dealloying induces porosity and the formation of a pure Pt-skeleton surface covering a Ni-containing core (J. Snyder, I. McCue, K. Livi, J. Erlebacher, J. Am. Chem. Soc. 134, 8633 (2012); I. McCue, J. Snyder, X. Li, Q. Chen, K. Sieradzki, J. Erlebacher, Phys. Rev. Lett. 108, 225503 (2012)).

Homogenized NiPt/C nanoparticle catalysts were dealloyed, electrochemically characterized and assessed for oxygen reduction activity in a three electrode cell with a Pt mesh (Alfa Aesar) counter electrode and a Hg/Hg₂SO₄ (MSE) reference electrode. The reference electrode was calibrated against a hydrogen reference and found to have an offset of 0.716 V at 25° C., 0.710 V at 45° C. and 0.706 V at 60° C. The Hg/Hg₂SO₄ potential offset was further confirmed by multiple comparisons to other reference electrodes, as well as to the positions of characteristic peaks for H_{UPD} and Pt oxidation/reduction found in the literature (U. Paulus, A. Wokaun, G. Scherer, T. Schmidt, V. Stamenkovic, N. Markovic, P. Ross, Electrochim. Acta 47, 3787 (2002)). Prior to any electrochemical experiments, all glassware was cleaned by soaking a solution of concentrated H₂SO₄ (J. T. Baker, ACS grade) and Nochromix cleaner (Godax Laboratories, Inc.) for at least eight hours followed by through rinsing in Millipore water. All solutions were made using Millipore (MilliQ Synthesis A10) water with a resistivity greater than 18.2 MΩ cm.

In a first embodiment, nanoporous nanoparticles were made by dealloying them on a glassy carbon (GC) disk. Supported catalysts were dispersed in a 4:1 H₂O:IPA volume solution at a concentration of 3 mg_{catalyst} mL⁻¹, 0.4 μL mg_{catalyst}⁻¹ of a 5 wt. % Nafion®/IPA solution was added to the catalyst ink to aid in dispersion and adhesion of the catalyst particles to the GC disk (5 mm diameter, 0.196 cm², Pine Instruments). The GC disk, prior to loading with catalyst, was polished to a mirror finish using 0.1 micron diamond paste (Buehler) followed by sonication in Millipore water to remove contaminants. An appropriate volume of catalyst ink for a 12 μg_{Pt} cm⁻² loading was pipetted onto the GC disk and dried under a flow of argon to form a uniform layer. Great care was taken to form a homogeneous film as catalytic activity is strongly correlated to the quality of the catalyst layer on the disk (Y. Garsany, I. Singer, K. Swider-Lyons, J. Electroanal. Chem. 662, 396 (2011)).

Then, dealloying was performed in N₂-purged (Roberts Oxygen, Zero grade) 0.1 M HClO₄ by cycling the potential between 0.05 V and 1.2 V vs. RHE (Gamry 750 mA potentiostat) at 250 mV s⁻¹ for at least 50 cycles; all quantitative cyclic voltammograms (CV) used a sweep rate of 50 mV s⁻¹. The ECSA of the dealloyed catalysts was found through integration of the current in the hydrogen underpotential deposition (H_{UPD}) region of the CVs, specifically the hydrogen adsorption region of the curve, subtracting out the nonfaradaic current associated with double layer charging and assuming 210 μC cm⁻². After the catalyst was fully dealloyed, it was rinsed thoroughly in Millipore water and transferred to O₂ (Roberts Oxygen, Research grade) saturated 0.1 M HClO₄ at the desired temperature for measurement of the ORR activity. Using a Pine Instruments rotator (AFMSRCE), the GC disk was rotated at a desired rpm while running linear sweep voltammetry from 0.1 V to 1.1 V vs. RHE at 20 mV s⁻¹. Current-voltage data was corrected for ohmic iR drop using the procedure described in D. van der Vliet, D. Strmcnik, C. Wang, V. Stamenkovic, N. Markovic, M. Koper, J. Electroanal. Chem. 647, 29 (2010).

The stable residual composition of dealloyed Pt/Ni nanoparticles is close to Pt₃Ni, which is known to be a highly active composition for the ORR (V. Stamenkovic, B. Fowler, B. Mun, G. Wang, P. Ross, C. Lucas, N. Markovic, Science 315, 493 (2007)). Porosity formation during dealloying is fundamentally different than forming a porous material by sintering particles together into a loose compact. In dealloying, porosity forms at scales smaller than the individual crystallites comprising the material. As taught in U.S. Patent Application Publication No. US2011/0177432, which is incorporated herein by reference in its entirety, this effect leads to a porous material containing few grain boundaries. Grain boundaries are energetically unstable, and lead to sintering. Dealloyed porous materials are inherently more stable because they are essentially porous single crystals, with the diameter of pores and ligaments much smaller than any crystallite size. As shown by the lattice fringes evident in FIG. 1, the nanoporous nanoparticles in this embodiment are mostly defect-free single crystals.

In a second embodiment, nanoporous nanoparticles were made by collecting NiPt/C precursor material on a gold dish electrode and then dealloying in 0.1 M HClO₄ via potential cycling. In this way, hundreds-of-milligram quantity batches of np-NiPt/C were produced, and the method can easily be scaled up to produce larger scale batches. Dealloyed catalysts were subsequently cleaned through sonication in ultrapure water and then dried under flowing argon. The resulting np-NiPt/C catalysts had an average metal loading of 30 wt. % on the carbon support and a residual Ni content of 35 at. %. Half-cell RDE tests of np-NiPt/C produced in this manner showed identical catalytic activity as materials produced by dealloying the precursor on disks.

### Example 2

### Synthesis and Properties of Carbon-Supported Encapsulated Nanoporous Metal Nanoparticles

For the encapsulating material to aid in the ORR it must be protic, aiding in the shuttling of protons to the catalytic surface, it must be hydrophobic to prevent itself leaching out of the catalyst particles, it must be thermally stable, it must have an electrochemical stability window encompassing the potentials relevant to PEMFC operation, and most importantly, the encapsulating material cannot chemically interact with the catalyst surface, i.e., neither the cation nor the anion may adsorb onto the surface at any potential which would lead to blocking of catalytic sites and a lower ECSA. These criteria are adequately met by a class of superbase derived protic ionic liquids (ILs) developed by H. Luo et al. (H. Luo, G. Baker, J. S. Lee, R. M. Pagni, S. Dai, J. Phys. Chem. B 113, 4181 (2009)), which are easily synthesized by direct neutralization of a Brønsted acid, [bis(perfluoroethylsulfonyl)imide, beti], with a strong Brønsted base, [7-methyl-1,5,7-triazabicyclo[4.4.0]dec-5-ene, MTBD]. The protic [MTBD][beti] IL has an oxygen solubility approximately 2.4 times that of a dilute acidic solution (J. Snyder, T. Fujita, M. W. Chen, J. Erlebacher, Nature Mater. 9, 904 (2010)), an adequate electrochemical potential stability window, is highly hydrophobic and thermal stable beyond 150° C.

Porosity in bulk dealloyed Ni/Pt materials had previously been shown to soak up ILs (J. Snyder, T. Fujita, M. W. Chen, J. Erlebacher, Nature Mater. 9, 904 (2010) and as taught in U.S. Patent Application Publication No. US2011/0189589, which is incorporated herein by reference in its entirety). In U.S. Patent Application Publication No. US2011/0189589, porosity was filled by ionic liquid by immersing the porous material in ionic liquid, and then spinning off the excess. In the carbon-supported nanoporous metal nanoparticles here, such simple immersion coats the catalyst with far too much ionic liquid, and there is no obvious way to remove the excess.

Encapsulation of the nanoporous metal nanoparticles can be accomplished in the following way: (1) make a solution of ethanol containing an amount of ionic liquid within a factor of ten of the volume of pores in the entire catalyst, (2) disperse the nanoporous metal nanoparticles, either supported on carbon or not, into the ethanol/ionic liquid solution, and (3) let the ethanol evaporate away. Use of this procedure led to the remaining ionic liquid encapsulating the nanoporous metal nanoparticles.

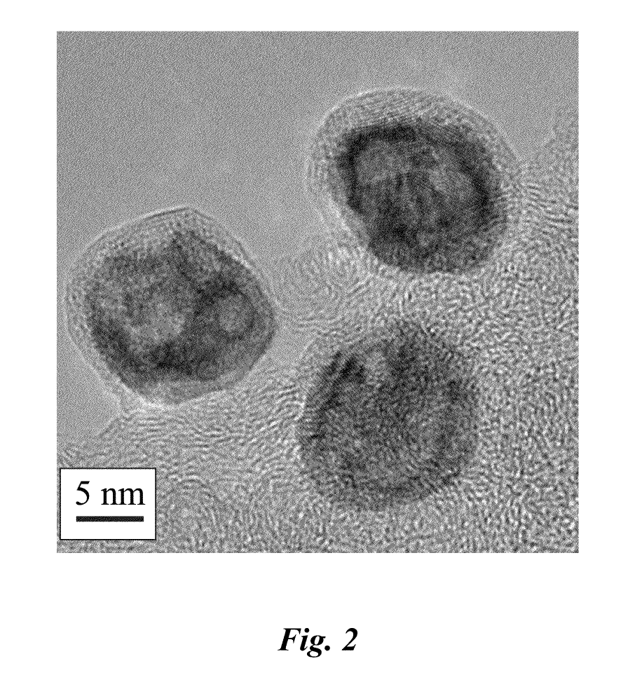

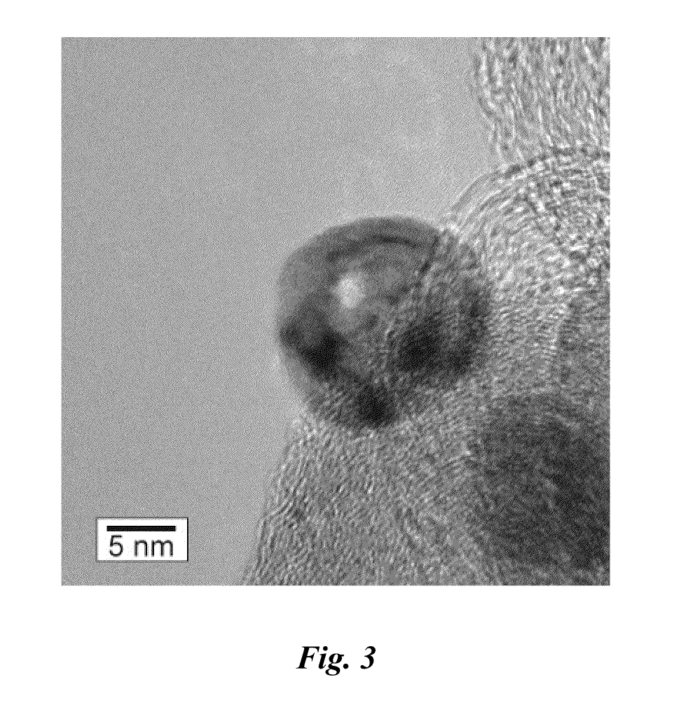

Another advantageous quality of ILs is their nearly nonexistent vapor pressure, meaning the IL will not evaporate during fuel cell operation at elevated temperature. The low vapor pressure also allows transmission electron microscopy imaging of the IL encapsulating the presently disclosed nanoporous nanoparticles as shown in FIG. 2, where an amorphous halo surrounding the nanoporous NiPt nanoparticles encapsulated with IL can be observed; in contrast, naked nanoporous nanoparticles show no halo (FIG. 3).

### Example 3

### Properties of Encapsulated Nanoporous Metal Nanoparticles

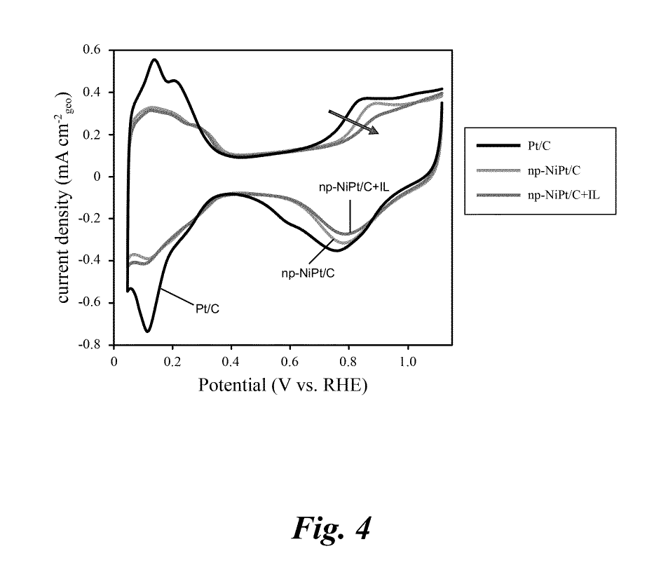

Referring now to FIG. 4, comparative cyclic voltammograms (CVs) for commercial 20 wt. % Pt/C, np-NiPt/C and np-NiPt/C+[MTBD][beti] are provided. A clear positive shift in the onset potential for Pt oxidation using np-NiPt/C can be observed, which is typical of such alloy catalysts, and IL encapsulation significantly further suppresses this, a consequence of the nonaqueous environment provided by the IL. Note, however, that Pt oxidation is not completely suppressed by the nonaqueous IL as, even for hydrophobic and protic ILs, there is a small solubility of water in the IL (J. Rollins, J. Conboy, J. Electrochem. Soc. 156, B943 (2009)). Suppression of Pt oxide formation improves ORR activity by decreasing active site blocking by OH_{ad} species. It is important to note that the CV for np-NiPt+[MTBD][beti] shows no extra faradaic processes other than those that typically occur on Pt and Pt alloys, namely hydrogen underpotential deposition (H_{UPD}) and Pt oxidation, indicating that there is no adsorption of ions from the IL onto the Pt surface. This behavior contrasts that of imidazolium-based ILs, in which free imidazole is known to irreversibly adsorb onto Pt surfaces (A. Noda, A. Susan, K. Kudo, S. Mitsushima, K. Hayamizu, M. Watanabe, J. Phys. Chem. B 107, 4024 (2003)). The nearly identical H_{UPD} regions with and without IL encapsulation further suggest that there is little if any site blocking and the IL is acting simply as a non-interacting electrolyte. The presence of fully formed H_{UPD} peaks also indicates the presence of water in the IL (J. Rollins, J. Conboy, J. Electrochem. Soc. 156, B943 (2009)).

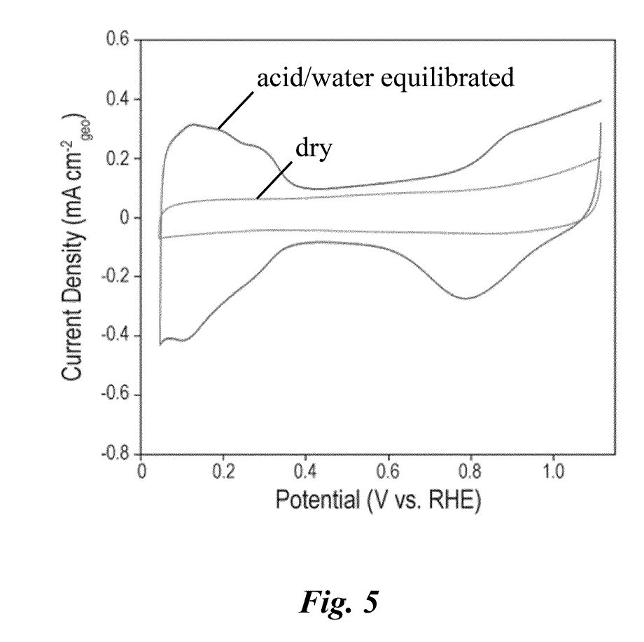

Interestingly, the initial CVs of np-NiPt/C+[MTBD][beti] taken immediately upon immersion in acid and prior to reaching an equilibrium with the aqueous electrolyte (FIG. 5) show significantly suppressed H_{UPD} and Pt oxidation currents, which increase after a short break-in period. Without wishing to be bound to any one specific theory, it is thought that this effect is due to saturation of the IL with water ions forming a two phase system similar to that of hydrated Nafion® (P. Choi, N. Jalani, R. Datta, J. Electrochem. Soc. 152, E123 (2005)). This adds additional proton conduction pathways, bulk hydronium diffusion through the water phase and intermolecular proton transfer between hydronium and water molecules (Grotthuss/relay mechanism), to the native, but slow, surface-hopping or vehicular mechanism (proton hopping along the amine sites of [MTBD]) that alone is operative in neat IL. In this sense, the IL encapsulation works fundamentally differently than the protic ILs that have been tested as nonhumidified electrolytes for fuel cells, which are uniformly afflicted by slow protonic transport (S. Lee, A. Ogawa, M. Kanno, H. Nakamoto, T. Yasuda, M. Watanabe, J. Am. Chem. Soc. 132, 9754 (2010)).

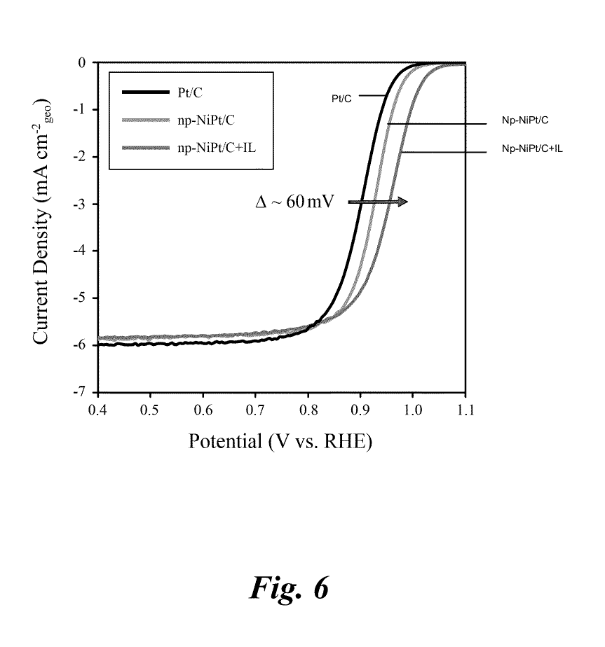

FIG. 6 contains the ORR polarization curves in O₂ saturated 0.1 M HClO₄ at 60° C. for commercial 20 wt. % Pt/C, np-NiPt/C and npNiPt/C+[MTBD][beti]; measurements of the Pt surface area and mass normalized activities for the catalysts at 25° C. and 60° C. are summarized in Table 1. The iR-corrected values for the mass and specific activity of 20 wt. % Pt/C are in agreement with other data reported in the literature (M. Nesselberger, S. Ashton, J. Meier, I. Katsounaros, K. Mayrhofer, M. Arenz, J. Am. Chem. Soc. 133, 17428 (2011); K. Ke, K. Hiroshima, Y. Kamitaka, T. Hatanaka, Y. Morimoto, Electrochim. Acta 72, 120 (2012)). The np-NiPt/C catalyst is considerably more active for the ORR than commercial catalyst, as evidenced by the positive shift in the half-wave potential. For instance, at 0.95 V vs. RHE, away from the mass-transport limited region near 0.9 V, the presently disclosed np-NiPt/C catalysts are more than six times as active as Pt/C. This factor of activity increase, however, is common for NiPt alloy catalysts (J. Kim, S. Lee, C. Carlton, Y. Shao-Horn, Electrochem. Solid-State Lett. 14, B110 (2011); J. Wu, J. Zhang, Z. Peng, S. Yang, F. Wagner, H. Yang, J. Am. Chem. Soc. 132, 4984 (2010)), as well as other nanoporous/dealloyed catalysts (M. Shao, K. Shoemaker, A. Peles, K. Kaneko, L. Protsailo, J. Am. Chem. Soc. 132, 9253 (2010); I. Dutta, M. Carpenter, M. Balogh, J. Ziegelbauer, T. Moylan, M. Atwan, N. Irish, J. Phys. Chem. C 114, 16309 (2010)). Encapsulation of np-NiPt nanoparticles with [MTBD][beti] results in nearly a factor of two further increase in activity, to over 2.0 A mg_{Pt}⁻¹ at 0.9 V vs. RHE. At 0.95 V vs. RHE, the ratio of specific activity for the bare np-NiPt/C and encapsulated catalyst is, within error, equal to the ratio of reactant O₂ solubilities in [MTBD][beti] and a 0.1 M acid electrolyte, in agreement with the results in (J. Snyder, T. Fujita, M. W. Chen, J. Erlebacher, Nature Mater. 9, 904 (2010)). Overall, in the half-cell experiments, the encapsulated nanoporous nanoparticle catalysts have an activity nearly an order of magnitude larger than that for commercial Pt/C catalysts. A comparison of the mass and surface-area specific activities of the encapsulated nanoporous metal nanoparticle catalyst for oxygen reduction is shown in Table 1.

### Example 4

### PEM Fuel Cells Using Encapsulated Nanoporous Metal Nanoparticle ORR Catalyst

In contrast to rotating disk electrode experiments, functional PEMFC catalyst layers must be designed to address issues related to mass transport of reactant gas, conduction of electrons and proton transport to the catalyst surface, as well as management of product water. With the goal of optimizing the triple-phase-boundary (J. Snyder, Y. Elabd, J. Power Sources 186, 385 (2009)), the advantages of the presently disclosed encapsulated nanoporous nanoparticle catalyst architecture are clear: (i) the hydrophobicity of the IL should aid in product water removal from the catalyst and surrounding areas, limiting flooding and promoting activity at high current densities; (ii) the protic nature and nominal water content of the IL will aid proton conductivity, especially within the interior of the porous particles where Nafion® cannot penetrate, as its hydrodynamic radius is on the order of 10³ nm (H. Chen, J. Snyder, Y. Elabd, Macromolecules 41, 128 (2008)). Note, in fact, that penetration of Nafion® into the pores, were it possible, would also be detrimental because catalytic sites would be blocked by sulfonate anion adsorption and the physical presence of the hydrophobic polymer backbone (R. Subbaraman, D. Strmcnik, A. Paulikas, V. Stamenkovic, N. Markovic, ChemPhysChem 11, 2825 (2010)); (iii) compared to traditional carbon supported nanoparticles, the nanoporous nanoparticles used here are an order of magnitude larger, even though their porosity allows them to have Pt ECSAs nearly as high as commercial catalyst. This geometric feature should limit diffusion and sintering of catalyst nanoparticles on the surface of the carbon supports, which is one of the main degradation and ECSA loss mechanisms for Pt/C(H. Colon-Mercado, H. Kim, B. Popov, Electrochem. Comm. 6, 795 (2004); H. Colon-Mercado, B. Popov, J. Power Sources 155, 253 (2006)); and (iv) as determined in the half-cell experiments, the mass and specific activity are significantly improved through IL encapsulation of the nanoporous nanoparticles.

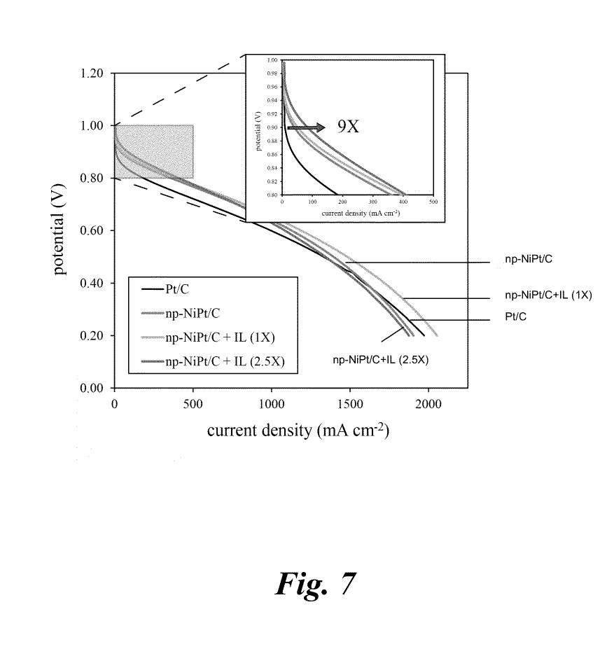

PEMFC polarization curves for commercial Pt/C, np-NiPt, and np-NiPt/C+[MTBD][beti] catalysts are shown in FIG. 7. Polarization curves were recorded after 3000 potential hold steps between 0.6 V and 1.0 V. While not representative of a true stability analysis, the lack of degradation during this break-in period does indicate that the IL was neither washed away from the catalyst nor were ionic species electrochemically reduced. Compared to commercial Pt/C, np-NiPt/C alone demonstrates a considerable increase in current density at all potentials within the kinetic and ohmic regions of the polarization curve, a result of the intrinsically higher activity of the alloy catalyst. Performance of IL-encapsulated catalysts depends sensitively on the amount of IL used. When the volume of IL exactly equals the porous volume of the metal nanoporous nanoparticles within the catalyst layer (0.025 μL_{IL} cm⁻²) two effects were observed: (i) a slight improvement in power at low overpotential likely due to the improved ORR kinetics associated with the higher O₂ solubility in the IL was observed; and (ii) performance is greatly improved at high current densities where the hydrophobicity of the IL helps to expel product water away from the porous catalyst particles limiting its effect on the mass transport of reactant O₂. While encouraging, the modest increase in activity at low overpotential does not match the presently disclosed half-cell results, which, without wishing to be bound to any one particular theory, is thought to be due to insufficient encapsulation of all of the porous particles in the catalyst layer. When twice as much IL was added, the activity improvement over Pt/C in the kinetic region of the polarization curve matched that measured in the half-cell, where a 60-mV positive shift was observed in each case.

The inset in FIG. 7 shows the kinetic region of the polarization curve, without iR correction, where the encapsulated catalyst architecture exhibited a nearly order of magnitude increase in activity at 0.9 V, reaching a current density of 100 mA cm⁻², even with a thick Nafion® membrane and a cathode loading of 0.2 mg_{Pt} cm⁻². Although excess IL improved PEMFC activity at lower overpotential, at high current density there was an increase in O₂ transport resistance through the catalyst layer. The obvious suspicion is that an excess of IL within the larger, approximately 100-nm pores between the carbon supports was slowing O₂ transport, suggesting that a direction to improve the encapsulating IL is to tailor the chemistry of the ionic species for enhanced O₂ diffusivity.

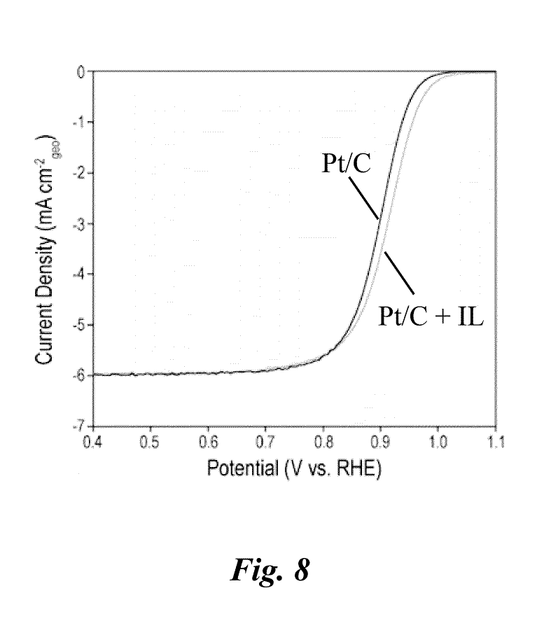

Mixing Pt/C with [MTBD][beti] leads to small improvements in ORR activity, as shown in FIG. 8. This improvement may be due to some uptake of the IL by the carbon support, but the presently disclosed results clearly show that encapsulation of nanoporous nanoparticles leads to considerably greater enhancements in catalytic activity.

### Example 5

### Specific and Mass Activity Measurements for 20 wt. % Pt/C, np-NiPt/C and np-NiPt/C+[MTBD][beti] IL

Table 1 provides specific and mass activity measurements for 20 wt. % Pt/C, np-NiPt/C and np-NiPt/C+[MTBD][beti] IL measured in the half cell at 60° C. (top row in each cell) and 25° C. (bottom row in each cell), in oxygen saturated 0.1 M HClO₄ with a sweep rate of 20 mV s⁻¹ and a rotation rate of 1600 rpm. Each data point is an average of at least three independent experiments. Currents are corrected for ohmic iR drops. Both the specific and mass activity of the catalyst exhibits a nearly order-of-magnitude increase from carbon supported Pt to the presently disclosed encapsulated nanoporous nanoparticle catalyst.

TABLE 1
Specific and Mass Activity Measurements for 20 wt. % Pt/C, np-
NiPt/C and np-NiPt/C + [MTBD][beti] IL

| | | 0.9 V vs. RHE | | 0.95 V vs. RHE | |
|---|---|---|---|---|---|
| | ECSA | Specific Activity | Mass Activity | Specific Activity | Mass Activity |
| | (m² g⁻¹_{Pt}) | (mA cm⁻²_{Pt}) | (mA μg⁻¹_{Pt}) | (mA cm⁻²_{Pt}) | (mA μg⁻¹_{Pt}) |
| Pt/C | 63 ± 1.8 | 0.65 ± 0.07 (60° C.) | 0.41 ± 0.06 | 0.080 ± 0.006 | 0.050 ± 0.006 |
| | | 0.51 ± 0.01 (25° C.) | 0.32 ± 0.01 | 0.072 ± 0.001 | 0.044 ± 0.001 |
| (np-NiPt)/C | 41 ± 1.5 | 3.34 ± 0.39 | 1.32 ± 0.22 | 0.49 ± 0.02 | 0.197 ± 0.004 |
| | | 2.66 ± 0.07 | 1.09 ± 0.03 | 0.35 ± 0.01 | 0.145 ± 0.005 |
| (np-NiPt + IL)/C | 41 ± 1.5 | 5.74 ± 0.19 | 2.19 ± 0.07 | 1.41 ± 0.05 | 0.54 ± 0.02 |
| | | 4.08 ± 0.30 | 1.68 ± 0.12 | 0.91 ± 0.03 | 0.37 0.01 |

### REFERENCES

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.
M. Debe, Nature 486, 43 (2012);
H. Gasteiger, S. Kocha, B. Sompalli, F. Wagner, Appl. Catal. B 56, 9 (2005);
M. Wilson, S. Gottesfeld, J. Applied Electrochem. 22, 1 (1992);
S. Lee, S. Mukerjee, J. McBreen, Y. Rho, Y. Kho, T. Lee, Electrochim. Acta 43, 3693 (1998);
V. Stamenkovic, B. Fowler, B. Mun, G. Wang, P. Ross, C. Lucas, N. Markovic, Science 315, 493 (2007);
J. Kim, S. Lee, C. Carlton, Y. Shao-Horn, Electrochem. Solid-State Lett. 14, B110 (2011);
J. Wu, J. Zhang, Z. Peng, S. Yang, F. Wagner, H. Yang, J. Am. Chem. Soc. 132, 4984 (2010);
J. Wang, H. Inada, L. Wu, Y. Zhu, Y. Choi, P. Liu, W. Zhou, R. Adzic, J. Am. Chem. Soc. 131, 17298 (2009);
V. Stamenkovic, B. Mun, K. Mayrhofer, P. Ross, N. Markovic, J. Am. Chem. Soc. 128, 8813 (2006);
J. Zhang, Y. Mo, M. Vukmirovic, R. Klie, K. Saski, R. Adzic, J. Phys. Chem. B 108, 10955 (2004);
J. Greely, I. Stephens, A. Bondarenko, T. Johansson, H. Hansen, T. Jaramillo, J. Rossmeisl, I. Chorkendorff, J. Norskov, Nature Chem. 1, 552 (2009);
J. Snyder, I. McCue, K. Livi, J. Erlebacher, J. Am. Chem. Soc. 134, 8633 (2012);
A. Marcu, G. Toth, R. Srivastava, P. Strasser, J. Power Sources, 208, 288 (2012);
J. Snyder, I. McCue, K. Livi, J. Erlebacher, J. Am. Chem. Soc. 134, 8633 (2012); I. McCue, J. Snyder, X. Li, Q. Chen, K. Sieradzki, J. Erlebacher, Phys. Rev. Lett. 108, 225503 (2012);
U. Paulus, A. Wokaun, G. Scherer, T. Schmidt, V. Stamenkovic, N. Markovic, P. Ross, Electrochim. Acta 47, 3787 (2002);
Y. Garsany, I. Singer, K. Swider-Lyons, J. Electroanal. Chem. 662, 396 (2011);
D. van der Vliet, D. Strmcnik, C. Wang, V. Stamenkovic, N. Markovic, M. Koper, J. Electroanal. Chem. 647, 29 (2010);
V. Stamenkovic, B. Fowler, B. Mun, G. Wang, P. Ross, C. Lucas, N. Markovic, Science 315, 493 (2007);
H. Luo, G. Baker, J. S. Lee, R. M. Pagni, S. Dai, J. Phys. Chem. B 113, 4181 (2009);
J. Snyder, T. Fujita, M. W. Chen, J. Erlebacher, Nature Mater. 9, 904 (2010);
J. Rollins, J. Conboy, J. Electrochem. Soc. 156, B943 (2009);
A. Noda, A. Susan, K. Kudo, S. Mitsushima, K. Hayamizu, M. Watanabe, J. Phys. Chem. B 107, 4024 (2003);
J. Rollins, J. Conboy, J. Electrochem. Soc. 156, B943 (2009);
P. Choi, N. Jalani, R. Datta, J. Electrochem. Soc. 152, E123 (2005);
S. Lee, A. Ogawa, M. Kanno, H. Nakamoto, T. Yasuda, M. Watanabe, J. Am. Chem. Soc. 132, 9754 (2010);
M. Nesselberger, S. Ashton, J. Meier, I. Katsounaros, K. Mayrhofer, M. Arenz, J. Am. Chem. Soc. 133, 17428 (2011);
K. Ke, K. Hiroshima, Y. Kamitaka, T. Hatanaka, Y. Morimoto, Electrochim. Acta 72, 120 (2012);
J. Kim, S. Lee, C. Carlton, Y. Shao-Horn, Electrochem. Solid-State Lett. 14, B110 (2011);
J. Wu, J. Zhang, Z. Peng, S. Yang, F. Wagner, H. Yang, J. Am. Chem. Soc. 132, 4984 (2010);
M. Shao, K. Shoemaker, A. Peles, K. Kaneko, L. Protsailo, J. Am. Chem. Soc. 132, 9253 (2010);
I. Dutta, M. Carpenter, M. Balogh, J. Ziegelbauer, T. Moylan, M. Atwan, N. Irish, J. Phys. Chem. C 114, 16309 (2010);
J. Snyder, T. Fujita, M. W. Chen, J. Erlebacher, Nature Mater. 9, 904 (2010);
J. Snyder, Y. Elabd, J. Power Sources 186, 385 (2009);
H. Chen, J. Snyder, Y. Elabd, Macromolecules 41, 128 (2008);
R. Subbaraman, D. Strmcnik, A. Paulikas, V. Stamenkovic, N. Markovic, ChemPhysChem 11, 2825 (2010);
H. Colon-Mercado, H. Kim, B. Popov, Electrochem. Comm. 6, 795 (2004); H. Colon-Mercado, B. Popov, J. Power Sources 155, 253 (2006).

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A catalyst for chemical reactions, comprising:
a porous metal nanoparticle capable of catalyzing a plurality of reactants to provide a reaction product, wherein the porous metal nanoparticle is encapsulated by a reaction-enhancing material;
wherein the reaction-enhancing material enhances attraction of at least one reactant of the plurality of reactants into one or more pores defined by the porous metal catalyst; and
wherein the reaction-enhancing material enhances expulsion of the reaction product from the one or more pores defined by the porous metal catalyst.

2. The catalyst of claim 1, wherein the reaction-enhancing material comprises a liquid in which at least one reactant is more soluble than a local environment that exposes the encapsulated porous metal nanoparticle to at least one reactant.

3. The catalyst of claim 1, wherein the reaction-enhancing material comprises a liquid in which the reaction product is less soluble than a local environment that receives the reaction product.

4. The catalyst of claim 1, wherein the porous metal nanoparticle catalyzes an oxygen reduction reaction to provide H₂O as a reaction product, wherein O₂ of the oxygen reduction reaction is more soluble in the reaction-enhancing material than the H₂O reaction product, and the reaction-enhancing material is hydrophobic.

5. The catalyst of claim 4, wherein the reaction-enhancing material comprises an ionic liquid.

6. The catalyst of claim 5, wherein the ionic liquid is at least one of MTBD-beti or MBTB-Tf₂N.

7. The catalyst of claim 1, wherein the porous metal nanoparticle has a specific surface area that is greater than about 5 m²/g and less than about 100 m²/g.

8. The catalyst of claim 1, wherein the porous metal nanoparticle has a specific surface area that is greater than 40 m²/g and less than 50 m²/g.

9. The catalyst of claim 1, wherein the porous metal nanoparticle has a specific surface area of about 41 m²/g.

10. The catalyst of claim 1, wherein the porous metal nanoparticle comprises platinum (Pt).

11. The catalyst of claim 10, wherein the porous metal nanoparticle comprises an alloy.

12. The catalyst of claim 11, wherein the porous metal nanoparticle comprises nickel (Ni).

13. The catalyst of claim 12, wherein the porous metal nanoparticle comprises an alloy comprising platinum (Pt) and nickel (Ni).

14. The catalyst of claim 13, wherein the porous metal nanoparticle comprises an alloy of the following formula:
PtₓNi₁₋ₓ,
wherein x has a numerical range from about at least 0.6 to about 1.

15. The catalyst of claim 14, wherein x is 0.67.

16. The catalyst of claim 1, wherein the porous metal nanoparticle comprises a metal selected from the group consisting of titanium, iron, cobalt, nickel, copper, iridium, rhenium, aluminum, manganese, palladium, osmium, rhodium, vanadium, chromium, and combinations thereof.

17. The catalyst of claim 1, wherein the porous metal nanoparticle has a diameter ranging from about 10 nm to about 100 nm.

18. The catalyst of claim 17, wherein the porous metal nanoparticle has a diameter ranging from about 12 nm to about 15 nm.

19. The catalyst of claim 1, wherein the porous metal nanoparticle is supported on carbon.

20. The catalyst of claim 1, wherein the porous metal nanoparticle has an ensemble average pore diameter and an ensemble average ligament diameter that are each less than a diameter of the porous metal nanoparticle itself.

21. The catalyst of claim 1, wherein the porous metal nanoparticle has an ensemble average pore diameter ranging from about 2 nm to about 10 nm and an ensemble average ligament diameter ranging from about 2 nm and about 10 nm.

22. A fuel cell, comprising:
a first electrode;
a second electrode spaced apart from the first electrode; and
an electrolyte arranged between the first and the second electrodes,
wherein at least one of the first and second electrodes is coated with a porous metal nanoparticle capable of catalyzing a plurality of reactants to provide a reaction product;
wherein the porous metal nanoparticle is encapsulated by a reaction-enhancing material;
wherein the reaction-enhancing material enhances attraction of at least one reactant of the plurality of reactants into one or more pores defined by the porous metal catalyst; and
wherein the reaction-enhancing material enhances expulsion of the reaction product from the one or more pores defined by the porous metal catalyst.

23. The fuel cell of claim 22, wherein the reaction-enhancing material comprises a liquid in which at least one reactant is more soluble than a local environment that exposes the encapsulated porous metal nanoparticle to at least one reactant.

24. The fuel cell of claim 22, wherein the reaction-enhancing material comprises a liquid in which the reaction product is less soluble than a local environment that receives the reaction product.

25. The fuel cell of claim 22, wherein the porous metal nanoparticle catalyzes an oxygen reduction reaction to provide H₂O as a reaction product, wherein O₂ of the oxygen reduction reaction is more soluble in the reaction-enhancing material than the H₂O reaction product, and the reaction-enhancing material is hydrophobic.

26. The fuel cell of claim 25, wherein the reaction-enhancing material comprises an ionic liquid.

27. The fuel cell of claim 26, wherein the ionic liquid is at least one of MTBD-beti or MBTB-Tf₂N.

28. The fuel cell of claim 22, wherein the porous metal nanoparticle has a specific surface area that is greater than about 5 m²/g and less than about 100 m²/g.

29. The fuel cell of claim 22, wherein the porous metal nanoparticle has a specific surface area that is greater than 40 m²/g and less than 50 m²/g.

30. The fuel cell of claim 22, wherein the porous metal nanoparticle has a specific surface area of about 41 m²/g.

31. The fuel cell of claim 22, wherein the porous metal nanoparticle comprises platinum (Pt).

32. The fuel cell of claim 31, wherein the porous metal nanoparticle comprises an alloy.

33. The fuel cell of claim 32, wherein the porous metal nanoparticle comprises nickel (Ni).

34. The fuel cell of claim 33, wherein the porous metal nanoparticle comprises an alloy comprising platinum (Pt) and nickel (Ni).

35. The fuel cell of claim 34, wherein the porous metal nanoparticle comprises an alloy of the following formula:
PtₓNi₁₋ₓ,
wherein x has a numerical range from about at least 0.6 to about 1.

36. The fuel cell of claim 35, wherein x is 0.67.

37. The fuel cell of claim 22, wherein the porous metal nanoparticle comprises a metal selected from the group consisting of titanium, iron, cobalt, nickel, copper, iridium, rhenium, aluminum, manganese, palladium, osmium, rhodium, vanadium, chromium, and combinations thereof.

38. The fuel cell of claim 22, wherein the porous metal nanoparticle has a diameter ranging from about 10 nm to about 100 nm.

39. The fuel cell of claim 38, wherein the porous metal nanoparticle has a diameter ranging from about 12 nm to about 15 nm.

40. The fuel cell of claim 22, wherein the porous metal nanoparticle is supported on carbon.

41. The fuel cell of claim 22, wherein porous metal nanoparticle has an ensemble average pore diameter and an ensemble average ligament diameter that are each less than a diameter of the porous metal nanoparticle itself.

42. The fuel cell of claim 22, wherein the porous metal nanoparticle has an ensemble average pore diameter ranging from about 2 nm to about 10 nm and an ensemble average ligament diameter ranging from about 2 nm and about 10 nm.

43. A method for preparing an encapsulated porous metal nanoparticle catalyst, the method comprising:
providing a metal alloy nanoparticle;
supporting the metal alloy nanoparticle on a conductive carbon support;
electrochemically de-alloying the metal alloy to provide a porous metal catalyst that catalyzes a plurality of reactants to provide a reaction product; and
encapsulating the porous metal nanoparticles with a reaction-enhancing material such that the reaction-enhancing material encapsulates partially or entirely the porous metal nanoparticle catalyst,
wherein the reaction-enhancing material enhances attraction of at least one reactant of the plurality of reactants into the pores defined by the porous metal catalyst, and
wherein the reaction-enhancing material enhances expulsion of the reaction product from the pores defined by the porous metal catalyst.

44. The method of claim 43, wherein the adding the reaction-enhancing material adds a liquid reaction-enhancing material that is drawn into and held within one or more pores defined by the porous metal nanoparticle catalyst by capillary forces.

45. The method of claim 43, wherein the reaction-enhancing medium is mixed with a solvent and porous metal nanoparticles and then the solvent is evaporated away.

46. The method of claim 45, wherein the solvent comprises ethanol.
